(19) United States
(12) Patent Application Publication
(10) Pub. No.: US 2012/0054601 A1
(43) Pub. Date: Mar. 1, 2012

(54) METHODS AND SYSTEMS FOR AUTOMATED CREATION, RECOGNITION AND DISPLAY OF ICONS

(75) Inventors: Philip R. Cohen, Bainbridge Island, WA (US); R. Matthews Wesson, Portland, OR (US); Michael Robin, Redmond, WA (US); David R. McGee, Bainbridge Island, WA (US)

(73) Assignee: ADAPX, INC., Seattle, WA (US)

(21) Appl. No.: 13/149,057

(22) Filed: May 31, 2011

Related U.S. Application Data
(60) Provisional application No. 61/349,423, filed on May 28, 2010.
(60) Provisional application No. 61/351,257, filed on Jun. 3, 2010.

(51) Int. Cl. G06F 17/00; G06F 17/30

(52) U.S. Cl. 715/243

(57) ABSTRACT

Methods, techniques, and systems for icon automated generation and placement are provided. Some embodiments provide an icon generation and placement system configured to ingest one or more icon templates, wherein the icon templates comprise an icon symbol, an icon label, and an icon dimensionality; populate source data for the one or more icon templates, wherein the source data is accessible by at least one of a speech recognition subsystem, handwriting recognition subsystem, and sketch recognition subsystem; generate an icon attribute table for the one or more icon templates; store the ingested one or more icon templates in an icon database; and place an icon, from the icon database into a selected location within a digital document in response to one or more multimodal inputs.

### PRIORITY CLAIM

This application claims priority to and the benefit of U.S. Provisional Application Ser. No. 61/349,423 entitled MULTIMODAL GIS SEMI-AUTOMATIC DEVELOPMENT TOOL filed May 28, 2010, and claims priority to and the benefit of U.S. Provisional Application Ser. No. 61/351,257 entitled METHOD AND APPARATUS FOR SEMI-AUTOMATIC CREATION, RECOGNITION AND DISPLAY OF FREE-HAND DRAWN SHAPES filed Jun. 3, 2010, both of which are incorporated by reference in their entirety.

### BACKGROUND OF THE INVENTION

A geographical information system (“GIS”) is an information system that provides the ability to create, save, interact with, analyze, and display geospatial data. In contrast, a map display system merely has the ability to present geo-registered maps/imagery. For example TerraGo's GeoPDF offers the ability to display maps as PDFs, and to record the geo-coordinates of a cursor, enabling “red line” markups, positioning of geo-registered icons as “stamps”, displaying a GPS trail, etc. The GIS is database driven—the visualization involves the rendering of properties of the data, both their geospatial extent as well as other attribute-values. Thus, a street in a map system is merely a set of colored geo-referenced pixels or lines, whereas for a GIS, it has properties such as street names, thickness (useful data for a concrete company), etc. The “geodatabase” in a GIS is typically a relational database, with tables representing types of objects, specific objects represented as rows, and columns that represent attributes of those objects. Typically, one of the columns provides spatial data (e.g., latitude-longitude, addresses, etc.) so that the object can be located on the Earth. The objects themselves may have complex shapes (point, line, or poly-line). In some GISs, the objects on a map user-interface (UI) are segregated into various “layers,” often based on object type, which the GIS user can turn on/off. The user interface to the GIS system will typically offer many different icons that control GIS functions, including the display of objects, and the invocation of analytical tools (e.g., shortest path algorithms, indivisibility calculations, terrain reasoning, etc). Typically, there will be a ‘legend’ on the GIS display, and rendered on the map, which associates symbols with the objects via a set of labels.

### BRIEF DESCRIPTION OF THE DRAWINGS

FIG. 1 is a block diagram of an Icon Generation and Placement Environment in accordance with an embodiment of the present invention;

FIGS. 2A-2D illustrate sample symbols and legends of an icon generation and placement system;

FIG. 3 illustrates a screen capture of a hand drawn shape that is converted into an icon from a legend in accordance with an embodiment of the present invention;

FIG. 4 is a computing system configured to operate an Icon Generation and Placement System in accordance with an embodiment of the present invention;

FIG. 5 is a flow diagram of an icon template ingestion provided by an Icon Generation and Placement System in accordance with an embodiment of the present invention; and

FIG. 6 is a flow diagram of an icon placement provided by an Icon Generation and Placement System in accordance with an embodiment of the present invention.

### DETAILED DESCRIPTION

Embodiments described herein provide enhanced computer- and network-based methods, systems, and techniques for automated creation, recognition and display of icons (e.g., symbols, objects, entities and/or the like) in a digital product (e.g., geographical information system, a computer-aided design, a building information management, a portable document format program, a spreadsheet program, and/or a presentation program). Example embodiments provide an icon generation and placement system that allows for one or more icons to be automatically ingested into a system. The system is accessible to a user via one or more multimodal inputs that enables the user to place the ingested icons at set locations within a digital product. An example multimodal system is found in U.S. Pat. No. 6,674,426, which is hereby incorporated by reference in its entirety.

In example embodiments, the Icon Generation and Placement System allows a user to automatically and/or semi-automatically build a set of icons in a digital product using an icon template. The user may, for example, scan a sheet of paper containing one or more icons with corresponding labels. The scanned digital document allows the system to generate an icon and build an icon attribute table with identifying source data for each of the input icons. For example, once an icon representing a resister and having the label “resister” is input into the system, the system then generates appropriate source data to allow for a speech recognition subsystem, a handwriting recognition subsystem and/or a sketch recognition subsystem to identify the icon. Advantageously, such an ingestion procedure allows for quick input of thousands of icons into the digital product. For example, an electrical engineer may input a thousand electrical engineering symbols into a computer-aided design program. In response, the system would automatically and/or semi-automatically build a legend containing all of the icons for use in the computer-aided design program.

In another example, geographical information system (“GIS”) icons are automatically ingested into the system and placed in a GIS legend. The icons may then be placed at a location within the GIS based on one or more multimodal inputs (e.g., voice, sketch, handwriting, gesture, and eye movement) by the user. Use of multimodal inputs allows the user to, for example, point to a location on a map and speak a name of an icon, thus causing the system to place an icon matching that name at the identified location on the map. By way of example, a user may point to a location on a virtual map and speak “river crossing,” which in turn results in the placement of a river crossing icon on the map at the identified location. The Icon Generation and Placement System may take the form of a digital paper and pen. In other embodiments a virtual representation of a digital product may be used, such as a projection of the digital product and/or the like.

In the Icon Generation and Placement System an icon database is automatically generated based on one or more ingested icons. Enabling the automatic and/or semi-automatic ingestion of icons allows the user to interact with a digital document using the ingested icons and one or more multimodal inputs. The multimodal inputs may provide locative (e.g. coordinates, positional information, and/or the like) and label information for the placement of an icon and/or a series of icons within the digital document.

The techniques of automatic creation, recognition and display of icons may be useful to create a variety of icon/symbol generation and placement operations where each icon/symbol includes positional and label information. In particular, the systems, methods, and techniques described herein may be used in GIS programs, sketching programs, computer-aided design programs and any system and/or any program that would benefit from the placement of an icon and/or symbol.

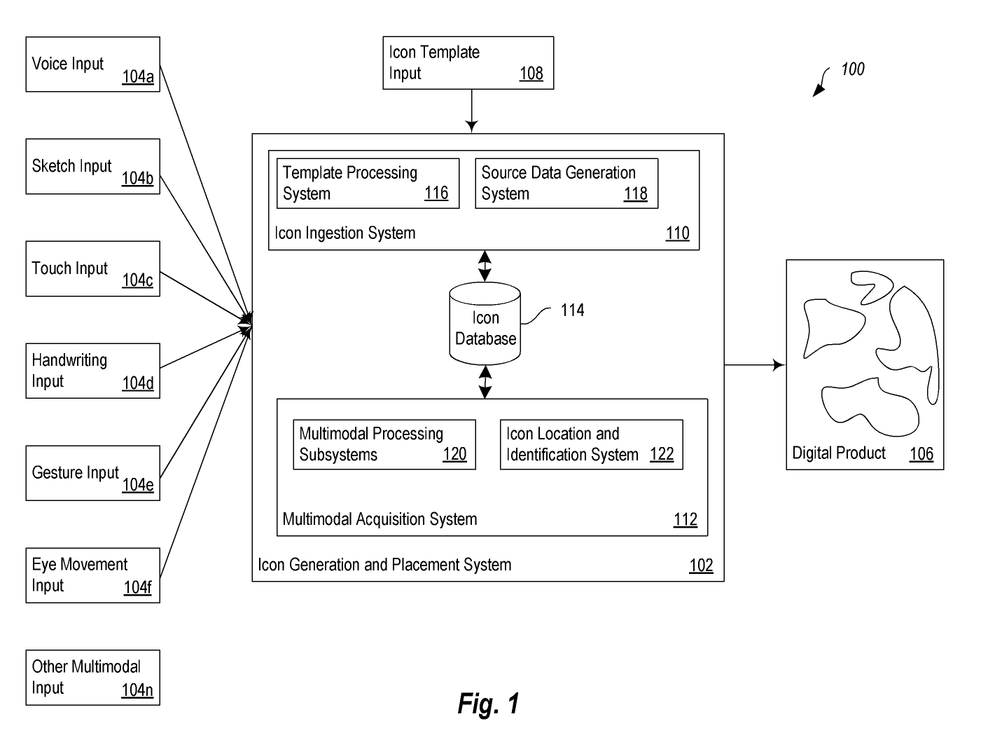

FIG. 1 is an example block diagram of components of an Icon Generation and Placement Environment. In particular, FIG. 1 depicts an icon generation and placement environment 100 that includes a Icon Generation and Placement System (“IGPS”) 102 (e.g., a code module/component), a plurality of multimodal inputs 104a-n, a digital product 106 and an icon template input 108. The components of the illustrated Icon Generation and Placement Environment 100 provide various logic (e.g. code, instructions, functions, routines, etc.) and/or services related to the ingestion of icons and the subsequent placement of icons based on multimodal inputs in the digital product. The IGPS 102 controls the input of the plurality of icons as well as the multimodal inputs from the user. In particular, the IGPS 102 provides functions relating to the overall management of the Icon Generation and Placement Environment 100. For example, the IGPS 102 may receive a plurality of icon templates from the icon template input 108 that are to be ingested for use in conjunction with the digital product 106. The IGPS 102 may also receive a plurality of inputs that provide an indication of a location or label of an icon. The IGPS 102 further interacts with the digital product 106 to place the icon at location within the digital product.

The IPGS 102 comprises an icon ingestion system 110 and a multimodal acquisition system 112. The icon ingestion system 110 is configured to ingest (e.g. input, scan, create templates, etc.) a plurality of icons for use in conjunction with a digital product. The icon templates may include an icon symbol, and icon label and/or an icon dimensionality (point, line, area, volume, etc.). The icon ingestion system 110 includes an icon database 114, template processing system 116 and a source data generation system 118.

The template processing system 116 is configured to create symbol recognizers for point, line, area and volume icons ingested into the system. The symbols may be recognized based on sketch inputs and/or placed in a digital document.

The source data generation system 118 creates source data for each of the icons. The source data may be used by the multimodal acquisition system 102 to build legends that enable the creation of point, line, area, and volume icons in a digital product. The source generation system 118 populates the speech recognition, natural language processing, handwriting recognition, and multimodal fusion rules, as well as the backend object creation. Other icon attributes may be added, such as additional shapes or symbology to indicate size or quality. For example, symbology relating the platoon, company and battalion in military symbology. The source data generation system 118 may also process requests for queuing, editing, and querying of the icon database 114.

The icon database 114 is configured to store the icon symbol and attributes relating to the icon. The icon database further stores information relating to an icon dimensionality such as whether the icon is a point, line, area, or volume icon.

The multimodal acquisition system 112 is configured to receive multimodal inputs from the multimodal inputs 104a-n for the placement of an icon within the digital product 106. The multimodal acquisition system includes multimodal processing subsystems 120 and an icon location and identification system 122.

The multimodal processing subsystems 120 include, but are not limited to, speech recognition, natural language processing, handwriting recognition, sketch recognition, gesture recognition, eye tracking, head tracking, and multimodal fusion routines. The multimodal processing subsystems 120 is configured to parse the multimodal inputs 104a-n, merge them into a combined data structure, and to transmit that data structure to the icon location and identification system 122.

The icon location and identification system 122 is in data communication with the icon database 114 to determine the requested icon based on a request received from the multimodal inputs 104a-n. Once the icon location and identification system 122 receives an identification of the requested icon, the icon location and identification system 122 calculates a location for the icon within a digital product 106. The location may be a point, a line or a volume in the digital product 106.

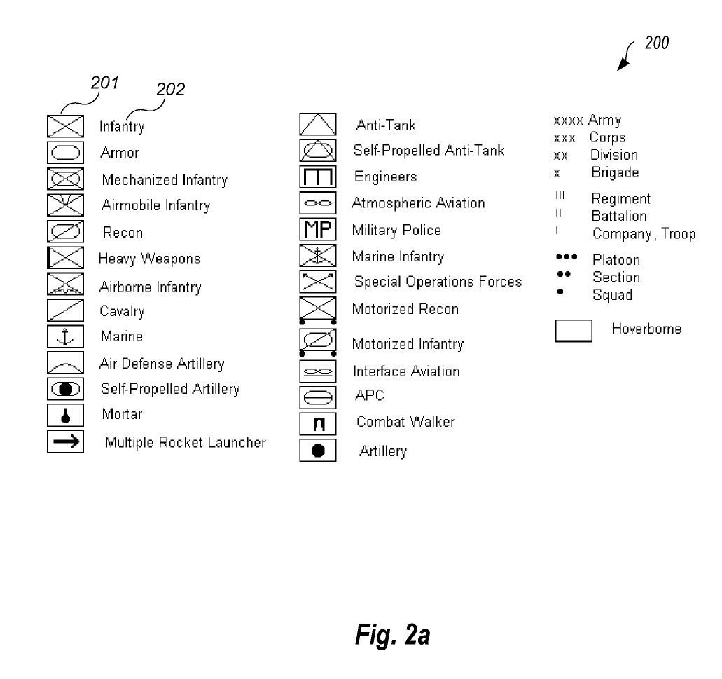

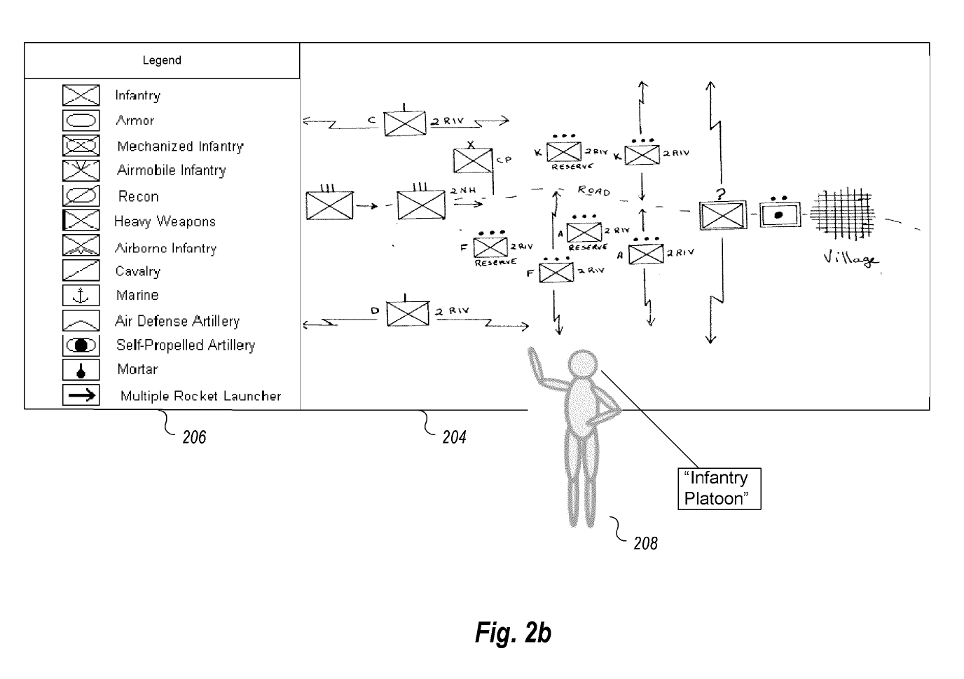

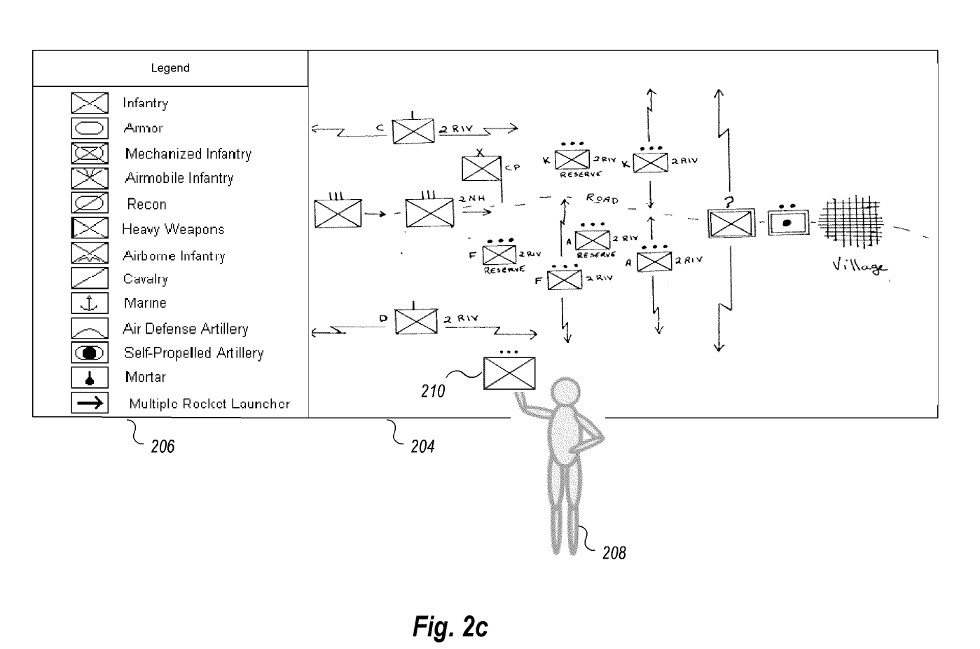

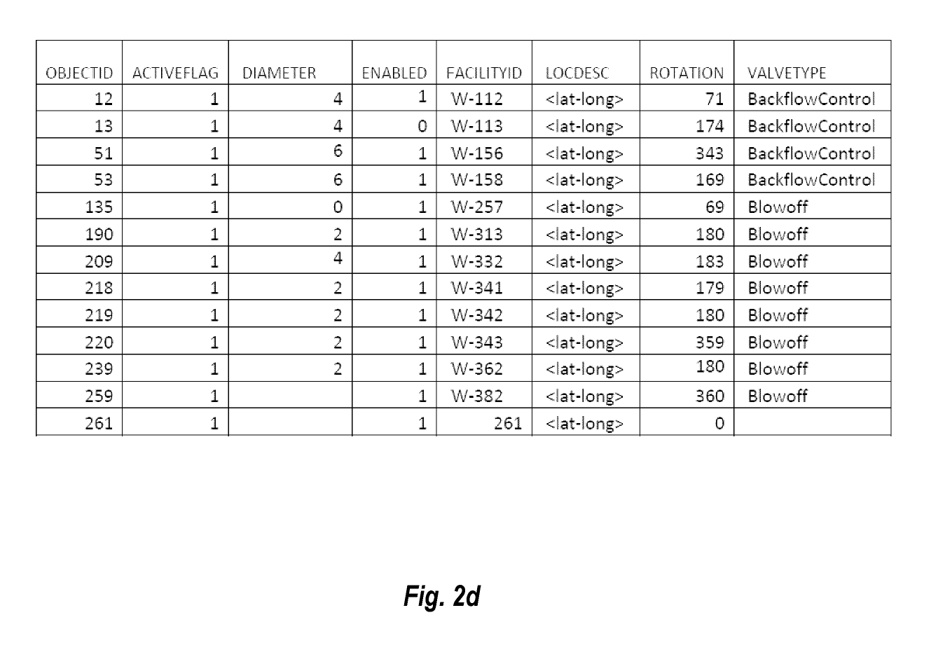

FIGS. 2A-D each illustrate aspects of an icon generation and placement system according to another embodiment. FIG. 2a illustrates an example template of icons 200. These icons include an icon symbol 201 and an icon label 202. By way of example, a template of icons 200 may be ingested in the icon generation and placement system for use in a digital product.

FIG. 2b illustrates a digital product in the form of a geographic information system (“GIS”) 204 utilized in a military environment. The GIS 204 displays a series of placed military symbols. The GIS 204 also includes a legend 206 of icons ingested by the icon generation and placement system as described in FIG. 2a. Once the icons are ingested into the icon generation and placement system, a user 208 may interact with the system. In this example, the user 208 speaks “infantry platoon” while pointing to a location on the GIS system 208. In response, the icon generation and placement system in FIG. 2c places the infantry company icon 210 in the GIS 204 at the specified location.

In another embodiment, the multimodal acquisition system (MAS) as described with reference to FIG. 1 would populate sketch recognition templates, natural language vocabulary, handwriting recognition vocabulary, grammar, speech language models, and multimodal fusion rules. There are two types of users in an example GIS environment—GIS specialists and end users. The GIS specialist would interact with the multimodal acquisition system, providing information on request that enables the system to support creation, editing, and query of the geodatabase by the end user via the map. The end user should be able to collect data in the field and thus need only speak to, and/or sketch/handwrite on a map/photo (displayed on a screen or printed on digital paper.) The end user should not need to interact with the geodatabase using database query techniques. Based on the MAS's acquisition of vocabulary, the system will use its general purpose grammar to generate a restricted context free grammar or statistical language model that will drive the speech recognition. If a corpus of interactions annotated for words and parses is available, the MAS will tailor the recognizers to accommodate the vocabulary, statistical language models, and grammar rule probabilities and multimodal fusion rule probabilities.

In the illustrated embodiment, the GIS specialist need only specify the layers and legends, causing the proposed multimodal acquisition system to then compile an ability to create and position such entities on the map with speech and/or sketch/handwriting. In order to supply additional data about those objects beyond their location and geographic shape, the acquisition system will provide its best inferences (based on large-scale linguistic resources available on the web, such as WordNet, COMLEX, and others) about how entities in the geodatabase can be describe linguistically, engaging the user in an interaction to verify its inferences.

Given a legend such as legend shown in FIG. 2b, the system that will use the legends to create point, line, area, and volume language and appropriate multimodal fusion rules. The data types that are indexed by these legend items already stipulate they are point, line, and poly-line type data, so the undertaking would automatically populate the speech recognition, natural language processing, handwriting recognition, gesture recognition, and multimodal fusion rules, as well as the backend object creation. After analyzing the legend, a user could thus be able to say “Detour route” while drawing a line, to obtain the proper geo-database object. Or, the user could touch the map and say “hazardous material” to create a point object of that type at that location.

An example use case includes, but is not limited to someone in the field who encounters an object of the type described in the geo-database (e.g., a water main valve) and wants to add/edit its properties using an icon attribute table dealing with water main valves. Assume the user decides to leave a valve in the field rotated at 180 degrees, rather than its current 174 degrees. He should be able to select the item on the map and say/write “Update rotation: 180 degrees” or “now rotated 180 degrees.” Note that the map could be on a tablet, PDA, or printed on digital paper.

In an example embodiment, the system determines from the user's touching an item on the map, which object it represents, then recognizes and parses the spoken/multimodal language, altering the database accordingly. A sample attribute table from a database is shown in FIG. 2D. The multimodal acquisition system will analyze columns as functions or binary predicates. For functions, the acquisition system will analyze the column headings for vocabulary, as described below, and treat cell values as words that are likely to be entered (via speech, handwriting, or keyboard), along with associated units (e.g., 180 degrees). The system may analyze the column headings, as well as the cell contents, in order to create appropriate language, populating the speech, language, and handwriting dictionaries accordingly. For example, it may need to infer that the object being represented is a Control Valve, which is a Valve. Columns with ID in their names may indicate a key field, i.e., a unique identifier for that entity (valve). ‘ActiveFlag,’ and Enabled will be recognized as binary fields, describing whether or not the control valve in that row is active or enabled, respectively. Morphological analysis will split the term ‘ActiveFlag,’ noting that ‘Flag’ is an indicator of a binary field (termed a “feature field” in TEAM). Using standard dictionary information, the system should then be able to infer that ‘Inactive’ is an adjective that applies to a valve and is indicated by value ‘0’. Likewise, ‘Disabled’ applies to a valve with value ‘0’. Diameter will be found to be a unit of measure (likely in inches), and that valves have diameters. FacilityID will need to be described—i.e., the identifier for the physical facility where the valves are located. It will be mapped to the preposition ‘in,’ e.g., “the control valves in this facility <point gesture>.” Rotation is a function of valves, and has a numerical value (likely in degrees). There may be adjectives that correspond to specific values—e.g., “open” means “Rotation=0 degrees,” and “shut” or “closed” means “Rotation=360 degrees.” Knowing these are adjectives will populate the grammar and speech systems accordingly. Finally VALVETYPE, is a column name that will be broken up by the word morphology routine, into ‘Valve’ modified by ‘Type,’ i.e., Type of Valve. Then, the field values will be parsed by the morphology routine, to separate ‘BackflowContror and ‘Blowoff’, into obvious multi-word noun compounds. For tables that include columns that include locative information (e.g., lat-longs), the system will add information to the grammar that would expect the object to be referred to via pointing, drawing, or via verbal locative reference (five miles due west of city hall’). A user may refer to column headers and column values using words that do not exactly match the column header and column strings.

In an advantageous embodiment, the icon generation and placement system is configured to semi-automatically generate the spoken language system, automatically generate sketch recognition vocabulary; automatically generate a point-line-area multimodal system, semi-automatically generate the editing language; and/or use of large scale resources to populate the set of choices for given column headings.

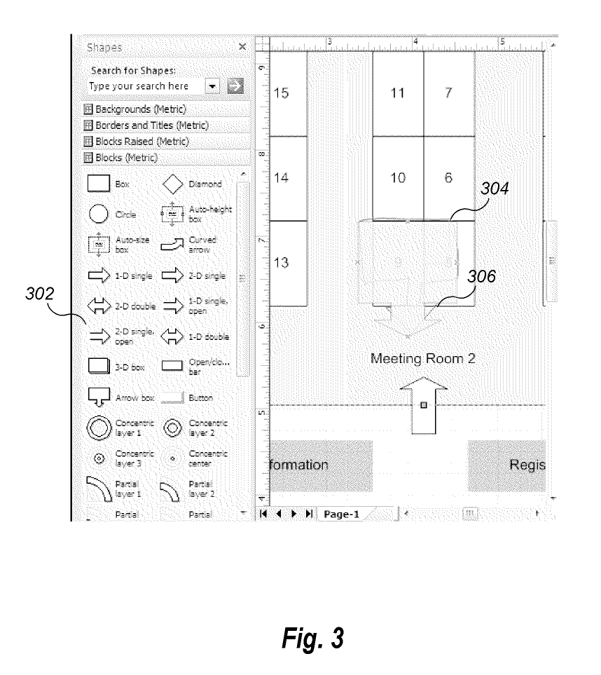

FIG. 3 illustrates a screen capture of a hand drawn shape that is converted into an icon from a legend in accordance with an embodiment of the current invention. In an example embodiment, a user may hand draw an icon such as arrow box 304. Such a hand drawing may be drawn using digital ink or may be drawn in a digital product. Once the shape is drawn, the sketch recognizer processes the sketch and attempts to match it to an icon stored in the template library that was created by processing the legend of the digital product 302. Once matched, the icon generation and placement system places the identified icon at the location in the digital product as identified by arrow box 306.

In an example embodiment, the icon generation and placement system is configured to recognize the shapes that are drawn by a user on a screen, paper, and/or other input surface and places them on the target digital product. During the ingestion of the icons, in an example embodiment, recognition templates are created so the icon generation and placement system can match the recognition templates against the user drawn input sketches. Templates may be “match templates” and/or graph templates.” Templates may bear labels and may be associated with unique identifiers.

In an example embodiment templates may be generated in the following manner: Zero or more exemplars are provided by the user by sketching them free-hand or provided automatically or semi-automatically using the icon generation and placement system. Zero or more exemplars may be provided by the user drawing a sketch of one or more of the previously existing templates. Templates may be automatically generated by the icon generation and placement system through image-processing based on raster and/or vector-based renderings representing shapes that either the user has selected, or through a file import of bitmap (PDF, TIFF, or other file format for) images. The user may activate the icon generation and placement system to fine-tune automatically-generated templates though but not limited to the following operations: choosing from multiple n-best guesses of generated templates; adjusting threshold for image processing; performing foreground/background inversions; supplying, deleting or moving control/anchor-points for connectors, placement and snapping operations; adding needed template modifications, such as outer boxes, or removing same if not needed; and/or supplying global or area based hints.

When processing user input, the icon generation and placement system may segment strokes into groups for processing—this segmentation step may be separate from or integrated with sketch recognition. The icon generation and placement system may separate strokes into actions using, but not limited to: template shape-recognition; graph shape-recognition; and/or custom stroke analysis. the icon generation and placement system performs actions including, but are not limited to: shape creation, including the association of the new shape with a template; identifier and unique identifier for the shape instance; shape connection; shape compounds; palette/toolbox choice operations (modal or one-shot) representing shapes, modes, color changes, editing or control operations; free-hand annotations to be shown as (colored) ink; handwritten text-based annotations to be passed to a handwriting recognizer, the returning recognized text to be associated with the shape; gestures representing editing operations; textual fields that are part of shapes to be passed to a text recognizer; associates the template labels and/or unique template and instance identifiers, with the recognized shape, enabling them to be used and displayed by the host application; executes the actions created above. The icon generation and placement system creates document artifacts, positioning the recognized shapes, possibly with their labels, on the background document where they were drawn, performing other actions as per the aforementioned actions.

An example template-matching algorithm is described herein. The input is a plurality of iconic images located in a document, file, or system's memory. These could be textual documents in PDF, TIFF, or some other document format. The icon generation and placement system may include digital products such as (but are not limited to) any CAD, GIS, drawing, text processing, spreadsheet system.

In an example embodiment, sketch recognition occurs using matching of template/shapes to digital ink strokes. In an example embodiment, there are two basic steps: create templates from the document, and match the templates to the user's drawn digital ink, returning the top N (a user settable parameter) as the recognizer's results. In other embodiments there may be additional steps as well as fewer steps. In one embodiment, templates are created using icon images taken from the document in question as raster images, or bitmaps. A rendering algorithm then may render the icons onto individual image surfaces, larger than 32×32 pixels. In an embodiment the icon template should provide semantics (meaning) for each image icon. For example in ArcMap, each icon in the map layout legend is known to correspond to a legend class, which gives database table field names and values for each icon, one of whose fields corresponds to a label. In an alternate embodiment, the icon template may give a title or other description for each icon (see FIG. 2a). An algorithm such as the Canny edge detection algorithm may be applied to each icon image, said variant described below herein. An example algorithm includes but is not limited to the following steps. The bitmap is converted into three byte arrays, one each for Red, Green, and Blue (or CMY or other color space representation. The values of Red/Green/Blue will be used here to mean any elements of the color space representation). Smoothing is applied to the Red, Green and Blue arrays using a simple filter. In contrast to an example Canny smoothing (5×5 filter), this is a short-range smoothing using a 3×3 filter, since icon details are assumed to be at a small resolution Smoothing is applied to Red, Green, and Blue components independently. At each point in {R,G,B} arrays, the X and Y gradients are calculated independently and then combined into a single two-dimensional gradient vector. The gradient at that point is considered to be the maximum of {R,G,B} gradients. If the magnitude of the gradient is smaller than a critical value, it is discarded. Otherwise the gradient is turned into an edge by rotating it ninety degrees. This ‘edge’ is a tiny one-pixel quantum of edge—length “1,” and a direction. In an embodiment, the Canny method of making edge pixels is not used, but instead make lines of these edges. The detected edges are then turned into lines kept in a glyph/shape, where a glyph or shape is a collection of lines, each one of which is a collection of sequential points. The lines are created by following an edge in one of the edge directions, continuing to the next edge which has the best qualities: is approximately “ahead” of the line in the line's direction (the approximation algorithm can be any of a number of algorithms that is approximately parallel to the line's current direction); is a strong edge (high-magnitude gradient). Rival edges which are near the line and are parallel, but were not followed, may be eliminated. The line is resampled to eliminate redundant points (those which lie in the middle of a straight segment). This process eliminates most duplicate edges. Some duplicated lines end up in the final image, but this does not cause great problems for the template recognizer. Templates are formed from each glyph. The templates can then be stored with the document, each template tagged by the semantic information that came with the image.

In one example embodiment a modified Hausdorff algorithm is used. For example, each stroke element a in input A is matched against each element b in stored B. Each a-b match is scored for location and orientation. The score for element a is the best of all a-b matches. In the usual Hausdorff matching, the score for A match B is the mean of the N-worst of all a-b matches, where N may be 1, a few, or all. The final score for A matching B is the minimum of A match B and B match A). An improvement may be made such that the good a-b or b-a matches are also used in scoring, instead of only the N-worst. In this scheme the weighting applied to the score of each a-b match would be (K—score), K being some small number, so that the high scoring matches (good matches) count for less, but still count for something, whereas in the usual Hausdorff matching the high scoring matches would be disregarded entirely, or simply averaged in.

In an example embodiment, the icon generation and placement system matches templates to hand drawn digital ink. When ink strokes (from digital pen or tablet or mouse or other drawing device) are received, in an embodiment, the ink strokes are separated into individual glyphs by space and time. In some embodiments ink strokes well separated on the writing surface will tend to be in separate shapes. Additionally, or alternatively ink strokes far apart in time will tend to be in separate shapes. Each individual drawn shape is preferably matched (using the algorithm above and/or the like) to each of the stored image templates. The best-scoring match may be used as the output symbol. “What” the output symbol is, is determined by the semantics that the template was tagged with, as well as a positioning of the icon on the background document at a location. The location of the output can be user defined, e.g., to be the center of the box that encloses the ink strokes, or at one of the four corners of the enclosing box.

In an embodiment related to linear and area/volume templates and assuming that the icon representing a line or area type is showing the texture of the line. Thus, line types can have symbols within them, perhaps repeated. An embodiment of the icon generation and placement system performs edge finding as before, isolating the parts that are not roughly linear to be the texture. When recognizing, if the ink seems to be linear in extent, pass a window over its parts and see if the parts (as visible in that window) have the texture as stored in the template. Similarly, drawings of areas often have fill patterns or textures both within the shape, and/or as part of the border of the shape. If the shape icon is deemed to be an area, then pass a window over both the border as well as the interior of the area icon examining them for pattern or texture, which becomes the set of templates assigned to this icon. When recognizing the icon that a user may have drawn, if it is deemed to be an area icon, apply a window around the edge and search within that window among the texture templates for the best scoring match. Likewise apply the templates to the ink within the enclosed area, evaluating the best scoring match. Combine the border and interior match scores according to one of a plurality of combination algorithms, including without limitation, maximum, minimum, product, linear combination, neural network, etc. Since the line and area icons are labeled, the user can create them via drawing a plain line or enclosed area and handwriting the label along the line, or within the area, respectively. The system will recognize that some of the strokes represent text, and some are drawings (based on one of a plurality of algorithms for separating ink genre types, e.g., examining the curvature of the strokes, etc.). Handwritten text is passed to a handwriting recognizer. Line or area shapes will then index into the template library along with the recognized text. If there is a repeated pattern within the line, or within the border or enclosed region of the area icon, the algorithm will find the smallest element of that repeating pattern as the texture. The user may then draw a linear or area icon using just one of those textures, with the resulting icon having the complete and replicated pattern.

Example embodiments described herein provide applications, tools, data structures and other support to implement an icon generation and placement system to be used for automated ingestion and placement of icons in a digital document. Other embodiments of the described techniques may be used for other purposes. In the following description, numerous specific details are set forth, such as data formats and code sequences, etc., in order to provide a thorough understanding of the described techniques. The embodiments described also can be practiced without some of the specific details described herein, or with other specific details, such as changes with respect to the ordering of the code flow, different code flows, etc. Thus, the techniques and/or functions described are not limited by the particular order, selection, or decomposition of steps described with reference to any particular routine.

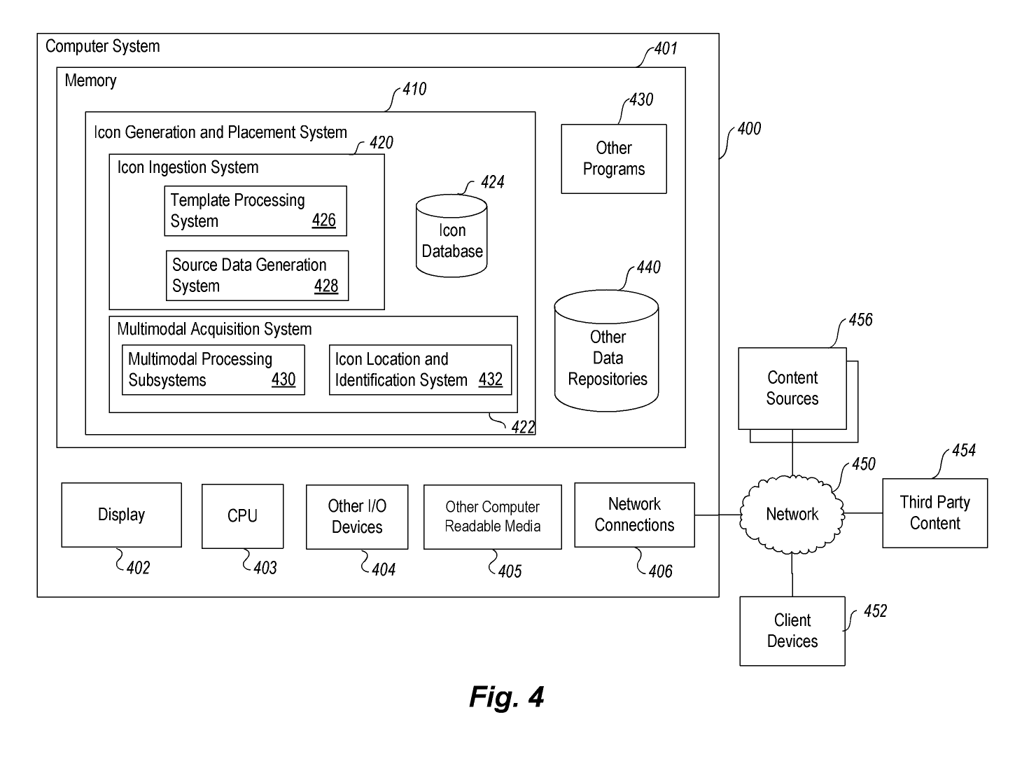

FIG. 4 is an example block diagram of an example computing device for practicing embodiments of an Icon Generation and Placement System. In particular, FIG. 4 shows a computing system 400 that may be utilized to implement an Icon Generation and Placement System 410. Note that one or more general purpose or special purpose computing systems/devices may be used to implement the Icon Generation and Placement System 410. In addition, the computing system 400 may comprise one or more distinct computing systems/devices and may span distributed locations. Furthermore, each block shown may represent one or more such blocks as appropriate to a specific embodiment or may be combined with other blocks. Also, the Icon Generation and Placement System 410 may be implemented in software, hardware, firmware, or in some combination to achieve the capabilities described herein.

In the embodiment shown, computing system 400 comprises a computer memory (“memory”) 401, a display 402, one or more Central Processing Units (“CPU”) 403, Input/Output devices 404 (e.g., keyboard, mouse, CRT or LCD display, and the like), other computer-readable media 405, and network connections 406. The Icon Generation and Placement System 410 is shown residing in memory 401. In other embodiments, some portion of the contents, some or all of the components of the Icon Generation and Placement System 410 may be stored on and/or transmitted over the other computer-readable media 405. The components of the Icon Generation and Placement System 410 preferably execute on one or more CPUs 403 and extract and provide quotations, as described herein. Other code or programs 430 (e.g., an administrative interface, a Web server, and the like) and potentially other data repositories, such as data repository 440, also reside in the memory 401, and preferably execute on one or more CPUs 403. Of note, one or more of the components in FIG. 4 may not be present in any specific implementation. For example, some embodiments may not provide other computer readable media 405 or a display 402.

In a typical embodiment, as described above, the Icon Generation and Placement System 410 includes an Icon Ingestion System 420 and a Multimodal Acquisition System 422. The Icon Ingestion System 420 includes a template processing system 426 and a source data generation system 428. The Icon Ingestion System 420 performs functions such as those described with reference to the Icon Ingestion System 110 of FIG. 1. The Multimodal Acquisition System 430 includes multimodal processing subsystem 430 and icon location and identification system 432. The Multimodal Acquisition System 422 performs functions such as those described with reference to the Multimodal Acquisition System 112 shown in FIG. 1.

The Icon Generation and Placement System 410 may interact via the network 450 with (1) content sources 456, (2) with third-party content 454 and/or (3) client devices/multimodal input sources 452. The network 450 may be any combination of media (e.g., twisted pair, coaxial, fiber optic, radio frequency), hardware (e.g., routers, switches, repeaters, transceivers), and protocols (e.g., TCP/IP, UDP, Ethernet, Wi-Fi, WiMAX) that facilitate communication between remotely situated humans and/or devices. The client devices 452 include desktop computing systems, notebook computers, mobile phones, smart phones, digital pens, personal digital assistants, and the like.

In an example embodiment, components/modules of the Icon Generation and Placement System 410 are implemented using standard programming techniques. For example, the Icon Generation and Placement System 410 may be implemented as a “native” executable running on the CPU 403, along with one or more static or dynamic libraries. In other embodiments, the Icon Generation and Placement System 410 may be implemented as instructions processed by a virtual machine that executes as one of the other programs 403. In general, a range of programming languages known in the art may be employed for implementing such example embodiments, including representative implementations of various programming language paradigms, including but not limited to, object-oriented (e.g., Java, C++, C#, Visual Basic.NET, Smalltalk, and the like), functional (e.g., ML, Lisp, Scheme, and the like), procedural (e.g., C, Pascal, Ada, Modula, and the like), scripting (e.g., Perl, Ruby, Python, JavaScript, VBScript, and the like), and declarative (e.g., SQL, Prolog, and the like).

The embodiments described above may also use either well-known or proprietary synchronous or asynchronous client-server computing techniques. Also, the various components may be implemented using more monolithic programming techniques, for example, as an executable running on a single CPU computer system, or alternatively decomposed using a variety of structuring techniques known in the art, including but not limited to, multiprogramming, multithreading, client-server, or peer-to-peer, running on one or more computer systems each having one or more CPUs. Some embodiments may execute concurrently and asynchronously, and communicate using message passing techniques. Equivalent synchronous embodiments are also supported. Also, other functions could be implemented and/or performed by each component/module, and in different orders, and by different components/modules, yet still achieve the described functions.

In addition, programming interfaces to the data stored as part of the Icon Generation and Placement System 410 can be made available by standard mechanisms such as through C, C++, C#, and Java APIs; libraries for accessing files, databases, or other data repositories; through languages such as XML; or through Web servers, FTP servers, or other types of servers providing access to stored data. The icon database 424 may be implemented as one or more database systems, file systems, or any other techniques for storing such information, or any combination of the above, including implementations using distributed computing techniques.

Different configurations and locations of programs and data are contemplated for use with techniques described herein. A variety of distributed computing techniques are appropriate for implementing the components of the illustrated embodiments in a distributed manner including but not limited to TCP/IP sockets, RPC, RMI, HTTP, Web Services (XML-RPC, JAX-RPC, SOAP, and the like). Other variations are possible. Also, other functionality could be provided by each component/module, or existing functionality could be distributed amongst the components/modules in different ways, yet still achieve the functions described herein.

Furthermore, in some embodiments, some or all of the components of Icon Generation and Placement System 410 may be implemented or provided in other manners, such as at least partially in firmware and/or hardware, including, but not limited to one or more application-specific integrated circuits (“ASICs”), standard integrated circuits, controllers executing appropriate instructions, and including microcontrollers and/or embedded controllers, field-programmable gate arrays (“FPGAs”), complex programmable logic devices (“CPLDs”), and the like. Some or all of the system components and/or data structures may also be stored as contents (e.g., as executable or other machine-readable software instructions or structured data) on a computer-readable medium (e.g., as a hard disk; a memory; a computer network or cellular wireless network or other data transmission medium; or a portable media article to be read by an appropriate drive or via an appropriate connection, such as a DVD or flash memory device) so as to enable or configure the computer-readable medium and/or one or more associated computing systems or devices to execute or otherwise use or provide the contents to perform at least some of the described techniques. Some or all of the system components and data structures may also be stored as data signals (e.g., by being encoded as part of a carrier wave or included as part of an analog or digital propagated signal) on a variety of computer-readable transmission mediums, which are then transmitted, including across wireless-based and wired/cable-based mediums, and may take a variety of forms (e.g., as part of a single or multiplexed analog signal, or as multiple discrete digital packets or frames). Such computer program products may also take other forms in other embodiments. Accordingly, embodiments of this disclosure may be practiced with other computer system configurations.

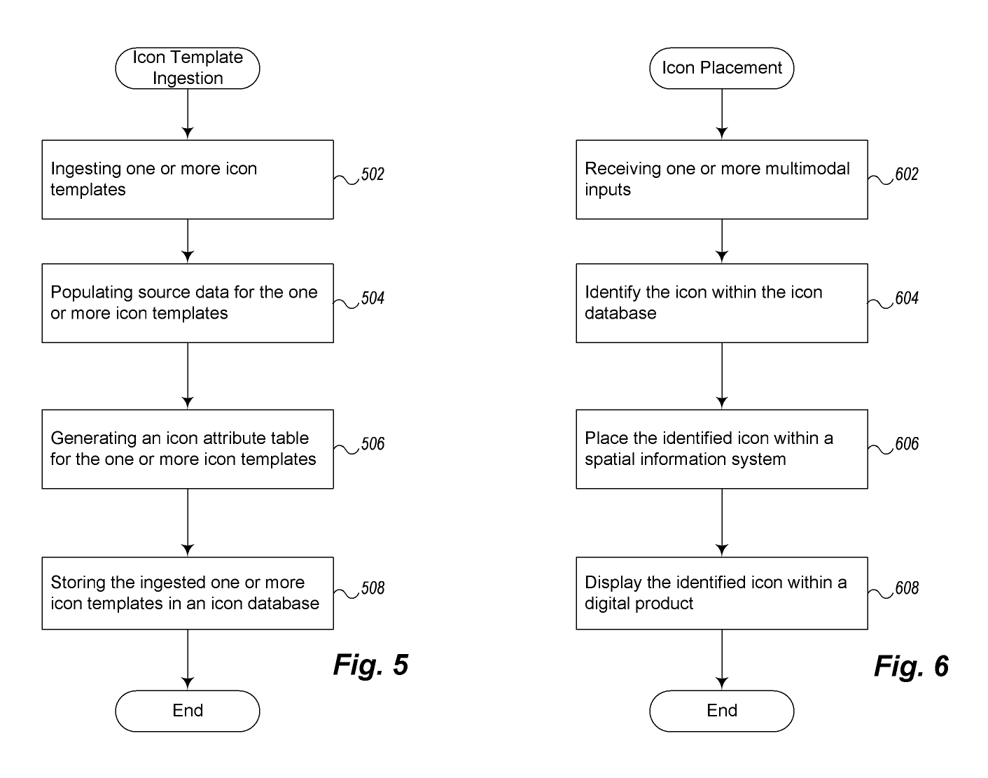

FIG. 5 is an example flow diagram of example icon template ingestion provided by an example embodiment of the Icon Generation and Placement System. In particular, FIG. 6 illustrates a process that may be implemented by, for example, one or more elements of the Icon Generation and Placement System 102.

The illustrated process begins at block 502, where it ingests one or more icon templates. The received icon templates may include symbols and or contextual information such as labels, as is shown with reference to FIG. 2a. At block 504, the process populates source data for the one or more icon templates. As described herein, the source data includes populating an attribute table with information relating to the icon that can be used by the multimodal processing subsystems. For example, source data may enable the use of speech recognition software. At block 506, the process generates an icon attribute table for the one or more icon templates. As described above, the icon attribute table includes the populated source data. At block 508, the process stores the ingested one or more icon templates in an icon database, such as icon database 114 shown in FIG. 1. After block 508 the process performs other processing and/or ends.

Some embodiments perform one or more operations/aspects in addition to, or instead of, the ones described with reference to the process of FIG. 5. For example, in one embodiment, the process includes a loop that repeatedly receives and processes requests, so as to perform bulk searches using multiple indications of desired content and multiple content sources. In another embodiment, the process of FIG. 5 is invoked in an on-demand manner in response to a received user interface request.

FIG. 6 is an example flow diagram of example icon placement provided by an example embodiment of the Icon Generation and Placement System. In particular, FIG. 6 illustrates a process that may be implemented by, for example, one or more elements of the Icon Generation and Placement System 102.

The illustrated process begins at block 602, where the process receives one or multimodal inputs. As described herein the multimodal inputs may be a single input or plurality of related inputs. In one example embodiment, the multimodal inputs may comprise location information and label information for an icon. Using the received one or more multimodal inputs, at block 604, the process identifies the icon within the icon database, such as icon database 114 shown in FIG. 1. The system then places the identified icon within a spatial information system at block 606. A spatial information system may be used to provide spatial location information so as to allow the placement of an icon within a digital product. At block 608, the identified icon is displayed within the digital product. After block 608, the process ends.

From the foregoing it will be appreciated that, although specific embodiments have been described herein for purposes of illustration, various modifications may be made without deviating from the spirit and scope of this disclosure. For example, the methods, techniques, and systems for content recommendation are applicable to other architectures. Also, the methods, techniques, and systems discussed herein are applicable to differing query languages, protocols, communication media (optical, wireless, cable, etc.) and devices (such as wireless handsets, electronic organizers, personal digital assistants, portable email machines, game machines, pagers, navigation devices such as GPS receivers, digital pens, etc.).

1. A computer-implemented method for generating and placing icons, the method comprising:
ingesting an icon template, wherein the icon template includes an icon symbol, an icon label, and an icon dimensionality;
populating source data for the icon template, wherein the source data is accessible by at least one subsystem;
generating an icon attribute table for the icon template;
storing the ingested icon template in an icon database; and
placing an icon, from the icon database, into a selected location within a digital document in response to a multimodal input.

2. The method of claim 1 wherein placing the icon further includes:
receiving one or more multimodal inputs that provide locative and label information for the placement of an icon in a digital product;
identifying the icon within an icon database based on the one or more multimodal inputs;
placing the identified icon within a spatial information system based on the provided locative information, wherein the spatial information system generates spatial coordinates for the placement of the icon in the digital product; and
displaying the identified icon at the generated coordinates within the digital product.

3. The method of claim 2 wherein the multimodal inputs identify icon attributes.

4. The method of claim 3, wherein the icon attributes further comprise at least one of an icon dimensionality, icon label, and an icon shape.

5. The method of claim 3 wherein an icon dimensionality defines the icon as at least one of a point, line, area, and volume icon.

6. The method of claim 3 wherein the multimodal input is selected from the group of multimodal inputs consisting of voice, sketch, touch, handwriting, gesture, and eye movement.

7. The method of claim 6 wherein the digital product is selected from the group of digital products consisting of a diagramming program, a geographical information system, a computer-aided design, a building information management, a portable document format program, a spreadsheet program and a presentation program.

8. The method of claim 2 wherein the subsystems are selected from the group of multimodal inputs consisting of a speech recognition subsystem, handwriting recognition subsystem, and sketch recognition.

9. A computer-readable storage medium whose contents include instructions that, when executed, cause a computing system to automatically create sketch recognition templates, by performing a method comprising:
ingesting a digital product having an icon template, wherein the icon template includes an icon symbol, an icon label, and an icon dimensionality;
generating a sketch recognition template for the icon template;
populating source data for the icon template, wherein the source data is accessible by at least one subsystem;
generating an icon attribute table for the icon template; and
storing the ingested icon template in an icon database.

10. The computer-readable storage medium of claim 9 further comprising:
receiving a sketch input of an icon at a location in a digital product;
matching the sketch input with the generated sketch recognition template; and
displaying the digital representation of the matched sketch input at the received location in the digital product.

11. The computer-readable storage medium of claim 10 wherein matching the sketch input comprises executing a modified Hausdorff algorithm, the modified Hausdorrf algorithm comprises:
generating a match value for a match between a sketch input and the generated sketch recognition template, based on a location and orientation of the sketch input;
generating a weight value that represents the amount of error for each element of the match, wherein each element is weighted more based on the amount of error; and
selecting the icon with the least error value.

12. The computer-readable storage medium of claim 10 wherein placing the icon further includes:
receiving one or more multimodal inputs that provide locative and label information for the placement of an icon in a digital product;
identifying the icon within an icon database based on the one or more multimodal inputs;
placing the identified icon within a spatial information system based on the provided locative information, wherein the spatial information system generates spatial coordinates for the placement of the icon in the digital product; and
displaying the identified icon at the generated coordinates within the digital product.

13. The computer-readable storage medium of claim 12, wherein the icon attributes further comprise at least one of an icon dimensionality, icon label, and an icon shape.

14. The computer-readable storage medium of claim 13 wherein an icon dimensionality defines the icon as at least one of a point, line, area, and volume icon.

15. The computer-readable storage medium of claim 13 wherein the multimodal input is selected from the group of multimodal inputs consisting of voice, sketch, touch, handwriting, gesture, and eye movement.

16. The computer-readable storage medium of claim 15 wherein the digital product is selected from the group of digital products consisting of a diagramming program, a geographical information system, a computer-aided design, a building information management, a portable document format program, a spreadsheet program and a presentation program.

17. The computer-readable storage medium of claim 13 wherein the subsystems are selected from the group of multimodal inputs consisting of a speech recognition subsystem, handwriting recognition subsystem, and sketch recognition.

18. A computing system configured to generate and place icons, comprising:
a memory;
an icon ingestion system, stored in the memory and configured, when executed on a computer processor, to ingest a icon template, wherein the icon template includes an icon symbol, an icon label, and an icon dimensionality and automatically populate a database with an icon attribute table for the ingested icon template; and
a multimodal acquisition system, stored in the memory, and configured, when executed on a computer processor, to access the database having the automatically generated icon attribute table when one or more multimodal inputs are received that provide position and identification information of an icon in a digital product.

19. The computing system of claim 18 wherein the multimodal inputs identify icon attributes.

20. The computing system of claim 19 wherein the icon attributes further comprise at least one of an icon dimensionality, icon label, and an icon shape.
